(19) United States
(12) Patent Application Publication
(10) Pub. No.: US 2023/0023409 A1
(43) Pub. Date: Jan. 26, 2023

(54) MULTIMARKET PLACE FOR BUYING AND SELLING GOODS AND SERVICES UTILIZING A CAPPED RAFFLE SYSTEM

(71) Applicant: Shelby Thomas, Apollo Beach, FL (US)

(72) Inventor: Shelby Thomas, Apollo Beach, FL (US)

(21) Appl. No.: 17/814,809

(22) Filed: Jul. 25, 2022

Related U.S. Application Data
(60) Provisional application No. 63/203,482, filed on Jul. 24, 2021.

(51) Int. Cl. G06Q 30/02; G06Q 30/06

(52) U.S. Cl. CPC G06Q 30/0212; G06Q 30/0635; G06Q 30/0223

(57) ABSTRACT

An online raffle system and method allows a seller to offer a product and/or service at a validated price, and set raffle limits. Eligible consumers may purchase raffles for the product. When the raffle limit is reached within an allowed time, a winner is selected using multiple random number generations. The winner and other consumers are notified of the winning raffle. The product is provided to the winner. Funds received from sales of raffle tickets are disbursed, with portions going to the seller for the price and an administrative fee to the administrator of the raffle.

### RELATED APPLICATION

This application is a nonprovisional and claims the benefit of priority of U.S. Provisional Patent Application No. 63/203,482, filed Jul. 24, 2021, the entire contents of which are incorporated herein by this reference.

### FIELD OF THE INVENTION

This invention relates generally to an online marketplace, and, more particularly, to an online marketplace for purchasing and selling goods and/or services via a raffle system and method.

### BACKGROUND OF THE INVENTION

Online marketplaces for selling one's goods and services are well known. Businesses and individuals may offer and sell their goods, services and possessions through Ebay, Amazon.com, Upwork.com and countless other marketplaces. Auction sites, such as Ebay, allow a seller to benefit from demand. Some auction sites, such as DealDash, require bidders to pay for each bid, which marginally increases the price of the item until the end of the auction, at which point the item is sold to the final bidder. Traditional marketplaces such as Amazon allow a seller to offer goods at a set price. Such sites attract prospective buyers who are prepared to pay the full price for the item. That full price may be a listed price or the highest bid in an auction. Individuals who are not prepared or willing to pay such a price are discouraged.

What is needed is an alternative online marketplace where buyers can purchase one or more chances to acquire goods and/or services being offered, and where sellers control one or more parameters that define the sum total of all chances sold.

The invention is directed to overcoming one or more of the problems and solving one or more of the needs as set forth above.

### SUMMARY OF THE INVENTION

To solve one or more of the problems set forth above, in an exemplary implementation of the invention, a raffle system and method are provided. Using the system, a seller may post a good or service to be awarded to the winner of a raffle. The seller will set a maximum amount of tickets to be sold and/or price per ticket, enabling the consumer to have increased odds versus traditional raffle unlimited entries. A set price enables various calculated odds of winnings for each raffle ticket. Consumers may purchase (or otherwise procure) one or more raffle tickets. Each raffle ticket represents one or more chances to win the posted good or service. When the maximum number of tickets (or maximum value of tickets) has been sold within a time allowed for a raffle, a winner is selected. These maximums may be specified by the seller, an administrator or coded into the system. The winner's raffle ticket is selected from all raffle tickets issued in the raffle. A back-end computing system executes a selection process, which invokes a pseudo random number generator and nondeterministic seed, to select a winning raffle ticket. The winner and other consumers are then notified of the winning raffle ticket. Funds received from sales of raffle tickets are then disbursed, with a portion going to the seller and another portion going to the administrator of the raffle, i.e., the raffle service provider.

An exemplary raffle method includes steps of a) associating a value with a product; b) receiving a request to purchase a raffle; c) determining if a raffle limit has been reached; d) if the raffle limit has not been reached, selling a raffle in response to the request to purchase; f) repeating steps b) through d) until the raffle limit has been reached; f) assigning a raffle id to each purchased raffle, each purchased raffle being one raffle of a plurality of purchased raffles; and g) randomly selecting one raffle id as a winning raffle id.

In one embodiment, the step of randomly selecting one raffle id as a winning raffle id includes steps of ranking each raffle id according to a determined parameter, and randomly selecting a rank. The determined parameter for each raffle id may be a time of sale of the raffle to which the raffle id is assigned. The step of randomly selecting a rank may include randomly generating an integer, e.g., using a pseudo-random number generator.

In another preferred embodiment, the step of randomly selecting one raffle id as a winning raffle id includes steps of assigning a random number to each raffle id, ranking each raffle id according to the assigned random number, and randomly selecting a rank. The step of randomly selecting a rank includes randomly generating an integer, e.g., using a pseudo-random number generator. The step of assigning a random number to each raffle id includes randomly generating a number for each raffle id, e.g., using a pseudo-random number generator.

The step of associating a value with a product may include receiving a proposed value, comparing the proposed value with an acceptable value, determining of the acceptable value equals or exceeds the proposed value, and if the acceptable value equals or exceeds the proposed value, then equating the value to the proposed value. The acceptable value may be contained in a list or database. If the list or database does not contain an acceptable value for the product, the acceptable value may be determined or verified through administrator intervention.

The step of determining if a raffle limit has been reached may include determining a first amount equal to the value and an administrative fee, determining the product of the number of raffles purchased and a price per raffle; determining if the product is less than the first amount, and if the product is not less than the first amount, determining (i.e., concluding) that a raffle limit has been reached, and if the product is less than the first amount, determining (i.e., concluding) that a raffle limit has not been reached.

### BRIEF DESCRIPTION OF THE DRAWINGS

The foregoing and other aspects, objects, features and advantages of the invention will become better understood with reference to the following description, appended claims, and accompanying drawings, where:

FIG. 1 is a high level block diagram of an exemplary raffle system according to principles of the invention; and

FIG. 2 is a high level flowchart of an exemplary raffle method according to principles of the invention; and

FIG. 3 is a high level flowchart of an exemplary parameter setting method for a raffle method according to principles of the invention; and

FIG. 4 is a high level flowchart of an exemplary selection methodology for a raffle method according to principles of the invention; and

FIG. 5 is a high level flowchart of another exemplary selection methodology for a raffle method according to principles of the invention; and

FIG. 6 is a table that conceptually illustrates random assignment, ranking, selection and lookup for an exemplary selection methodology for a raffle method according to principles of the invention; and

FIG. 7 is another table that conceptually illustrates random assignment, ranking, selection and lookup for an exemplary selection methodology for a raffle method according to principles of the invention; and

FIG. 8 is another table that conceptually illustrates random assignment, ranking, selection and lookup for an exemplary selection methodology for a raffle method according to principles of the invention.

Those skilled in the art will appreciate that the figures are not intended to be drawn to any particular scale; nor are the figures intended to illustrate every embodiment or implementation of the invention. The invention is not limited to the exemplary embodiments or implementations conceptually illustrated in the figures or the specific components, steps, sequences, or configurations shown in the figures.

### DETAILED DESCRIPTION

Using a raffle system and method according to principles of the invention, a seller or administrator may post a good or service to be awarded to the winner of a raffle. Posting may entail uploading images, entering text and amounts, and making selections, much in the same way products are typically posted for sale on online marketplaces. Key differences relate to this being a raffle system, instead of a conventional online marketplace.

A raffle method according to principles of the invention is implemented using a raffle system according to principles of the invention. The raffle systems includes various computer systems communicatively coupled via a computer network, such as the Internet. Using a computing device that is communicatively coupled to a server, a seller may post a good or service to be awarded to the winner of a raffle. In connection with the posting, the seller may control the odds of winning for each raffle ticket by setting a maximum amount of tickets to be sold and/or a price per ticket. In a preferred implementation, each raffle ticket is a virtual ticket represented by a unique id on a computing system and associated with an end user (e.g., a consumer). Using computing devices, consumers may purchase one or more raffle tickets. Each raffle ticket represents one or more chances to win. When the maximum number of tickets (or maximum value of tickets) has been sold within a time allowed for a raffle, a winner is selected. The winner's raffle ticket is selected from all raffle tickets issued in the raffle, using a pseudo random number generator and a nondeterministic seed. A back-end computing system executes a selection process, which invokes the pseudo random number generator and nondeterministic seed, to select a winning raffle ticket. The winner and other consumers are then notified of the winning raffle ticket. Funds received from sales of raffle tickets are then disbursed, with a portion going to the seller and another portion going to the administrator of the raffle, i.e., the raffle service provider.

Computer program code or “code” for carrying out operations (e.g., steps) according to the present invention may be written in any programming language compatible with the corresponding computing devices and operating systems. Software embodiments of the present invention do not depend on implementation with a particular programming language. The computer program code may be provided to a processor of a general-purpose computer, special purpose computer, or other programmable computing apparatus (e.g., a phone, personal digital assistant, tablet, laptop, personal computer, or computer server) as instructions, such that the instructions, which execute via the processor of the computer or other programmable data processing apparatus, create means for implementing the functions described herein. The computer code may be stored in a computer-readable memory that can direct a computer or other programmable data processing apparatus to function in a particular manner, such that the instructions stored in the computer-readable memory produce an article of manufacture including instruction means which implement the functions and perform the steps specified in the illustrations and described herein.

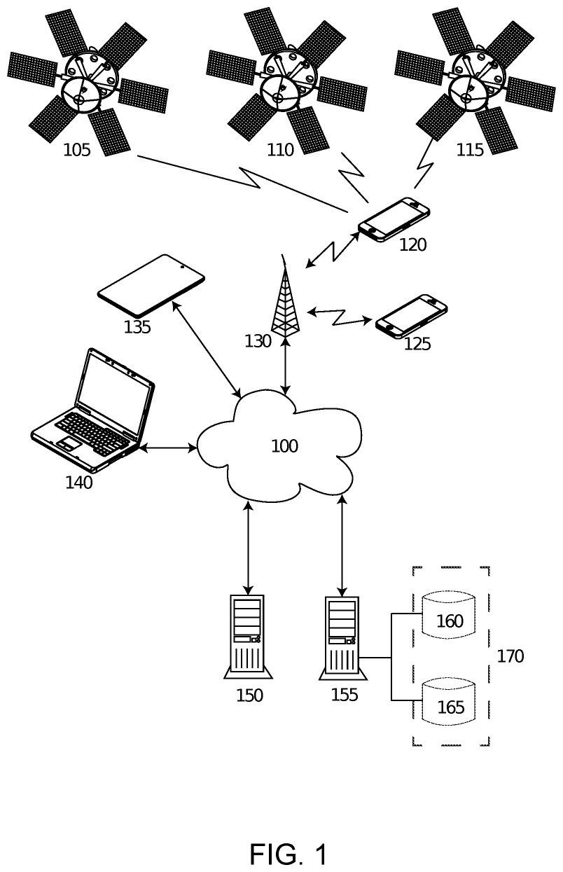

Referring now to FIG. 1, a high level block diagram of hardware components of a raffle system according to principles of the invention is conceptually illustrated. Consistent with the present invention, users of the system employ computing devices, such as a smartphones 120, 125, tablets 135, laptop computers 140, personal computers 150, kiosks, servers 155, or other computing devices, communicating in a wireless or wired mode via the Internet 100. The computing devices (i.e., clients or client devices) are equipped with software for inputting and displaying information in accordance with the methodologies described herein. Such software may comprise a web browser, a client application and/or a mobile device app. Some of the computing devices 120, 125 may be equipped with cellular wireless communication modules providing internet access via wireless cellular communication infrastructure 130. Some of the devices may be used by end users (sellers) for posting and managing goods and/or services to be raffled, while other devices may be used by end users (consumers) to procure raffle tickets and monitor the progress and status of the raffle, while still others may be used by end users (administrators) to administer and manage the raffle system.

A client application may organized products by categories, such as travel, automotive, electronics, accessories, furniture, decor, clothing and music. These categories are nonlimiting examples. Other categories may be provided in addition to and/or in lieu of any of the foregoing categories. A category of products may be further organized into subcategories. A category for products may be presented on a single screen, from which a user may drill down into subcategories in search of a product of interest. An administrative category may also be provided for account management and administrative functions.

Referring still to FIG. 1, one or more computers such as server 155 includes or has access to a database management system for managing raffle data, including posted product/service data, raffle ticket data, and all parameters for each raffle (e.g., value limits, raffle ticket prices, raffle ticket limits, and temporal limits). Limits constitute caps. One or more databases may contain aggregations of data records or files. A communications network interconnects the server 155, directly or indirectly through one or more additional computers, with the Internet 100. Interconnected computers communicate with each other through mechanisms such as inter-process communication, remote procedure call, distributed object interfaces, and various other program interfaces. The databases may be stored on one or more storage devices 160, 165, collectively the data storage 170. The database may be queried using various database access means such as SQL (Structured Query Language), a standard language for interacting with a database; Open Database Connectivity (ODBC), an open standard API for accessing a database; DCOM (Distributed Component Object Model), a set of Microsoft tools and program interfaces for enabling client program objects to request services from server program objects on another networked computer; Common Object Request Broker Architecture (CORBA), an architecture and specification which allows programs at different locations and developed by different vendors to interact in a network through an interface broker, or other interfaces and protocols. Illustratively, the clients 120, 125, 135-150 may execute one or more processes that interact with the server 155 to supply, access and manage data stored on the data storage 170. Each request received by the server 155 may be submitted as a TCP/IP communication packet including an IP address and socket number. In response to valid requests, the server 155 may provide data from the data storage 170, without compromising the integrity of the database.

In certain embodiments of a system and methodology according to the principles of the invention, a user's location may be required. By way of example, a raffle may be limited to consumers in certain states. Location may be user input or automatically determined using GPS data, IP trace or triangulation information. Some of the computing devices may be equipped with Global Positioning System (“GPS”) receivers for receiving signals from GPS satellites 105-115 to determine location of the device.

Certain clients 120-150 may not have access to a GPS service (for example, they may lack hardware necessary to support such a service); consequently, such GPS information may not be available for all clients 120-150. Also, certain GPS services do not operate or do not operate reliably in certain locations, such as indoors or other enclosed spaces. Thus, even if a client 120-150 does have the necessary hardware and software to support a GPS service, occasionally GPS information from the GPS service may not be available to a particular client 120-150.

IP trace information may include the public IP address of the client 120-150 and the set of IP addresses that data packets sent from the client 120-150 pass through to reach server 150. The public IP address of the client 120-150 may be determined by gathering the source IP address from the server socket receiving the client 120-150 connection. The list of hops through which the data packets sent from the client 120-150 go through may be determined by sending adaptive TTL (time to live) UDP packets to server 150 from the client 120-150. In order to determine if the client 120-150 is being an IP proxy, server 150 may correlate the list of hops with the public IP address of the client 120-150. In this way, server 150 may effectively discover the real public IP address of the client 120-150. The real public IP address of the client 120-150 is then matched against a database of Internet Service Providers (ISPs) which returns the probable address of the originating client 120-150 message. This probable address of the originating client 120-150 message may then be translated to a set of longitude and latitude coordinates.

Triangulation information for a client 120-150 may include a list of public Wi-Fi access points surrounding the client 120-150 as well as the signal strength of each Wi-Fi access point accessible by the client 120-150. The list of surrounding Wi-Fi access points, and their signal strength, may be formatted and correlated with a database of public Wi-Fi access points by server 150 to determine a probable set of longitude and latitude coordinates for the client 120-150. The database of public Wi-Fi access points employed by server 150 may be updated over time to reflect new information about available Wi-Fi access points.

The invention is not dependent upon location information. Certain implementations of the invention may not take location into consideration. In implementations that take location into consideration, certain types of location data may be more accurate or reliable than others. GPS information is more accurate and indicative of the correct physical location of a client 120-150; however, as explained above, GPS information for a particular client 120-150 may not always be available. Triangulation information, while not as accurate and reliable in identifying the correct physical location of a client 120-150 as GPS information, is more accurate and reliable than IP trace information. However, triangulation information also may not always be available, e.g., the client 120-150 may not be able to detect any nearby recognizable Wi-Fi access points. Additionally, while IP trace information is less accurate than either GPS information or triangulation information in determining the correct location of a client 120-150, it is always obtainable if the client 120-150 can communicate to server 150 over the Internet.

Additionally, a user may input location (e.g., an address) for a device, such as a personal computer, laptop 140 or tablet 135, that may not be equipped with a GPS receiver. For a device, such as a kiosk, at a fixed location (e.g., on a cruise ship or in a casino), the location of the device may be known and associated with a unique identifier (e.g., MAC address) for the device.

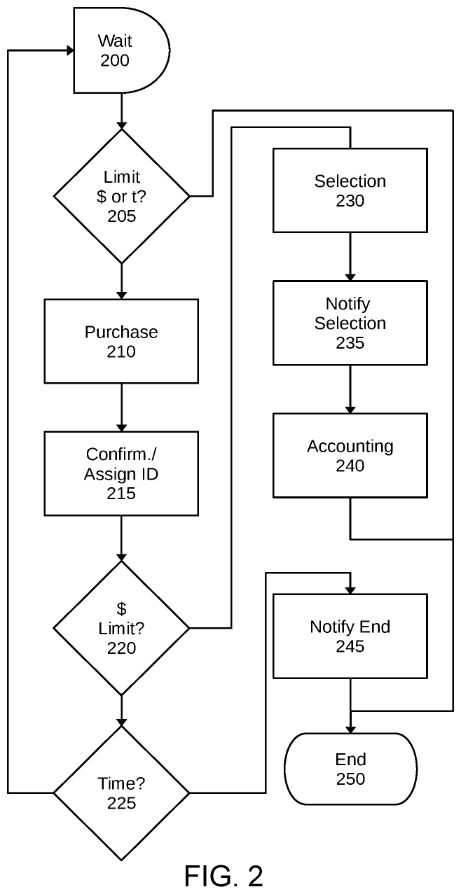

Referring now to FIG. 2, a high level flowchart for a raffle method for a posted product or service is conceptually illustrated. The system waits for a user to access the raffle, as in step 200. Upon user access, the system determines if limits (i.e, caps) have been exceeded, as in step 205. By way of example, if a maximum number of raffles or a maximum value of raffles has already been sold, or a time limit for completing the raffle has passed, then no further raffle ticket purchases may be made, and control proceeds to step 250. If limits have not been exceeded, then control proceeds to step 210 for a purchase. The user may have already set up an account, in which case, the user may be required to login to make a purchase. If the user has not already set up an account, the user may be required to do so as a condition for making a purchase. Account setup may entail providing personal information (e.g., name, address, age) and one or more methods of payment. In step 210, the user purchases one or more raffle tickets. Each purchase is confirmed and each raffle ticket is assigned a unique ID in step 215.

A user may purchase one or more tickets. Tickets may be offered at a price per ticket. Optionally, volume discounts may be provided. As another option, a user may be presented with the option of buying all remaining tickets (i.e., all unsold tickets up to the limit).

The method checks if each ticket is within allowable limits, and if each purchase is made within an allowable time. By way of example, in step 220, determinations are made if each purchased raffle ticket exceeds a limit (e.g., a value limit, such as a $1000 limit for a product valued at $1,000, or a limit on the number of tickets), as set by the seller, administrator or system. If a limit has been reached, control passes to step 230. In step 225, a determination is made if the time for purchasing raffle tickets has closed. If time has passed, control passes to step 245, where the user is notified that the raffle has ended.

If a raffle is limited to users in certain locations (e.g., certain states and/or countries), the system may determine the user's location from account information and/or using any of the location determination methods described above. If a user's location is outside an allowed region, then the system may prevent the user from purchasing raffle tickets.

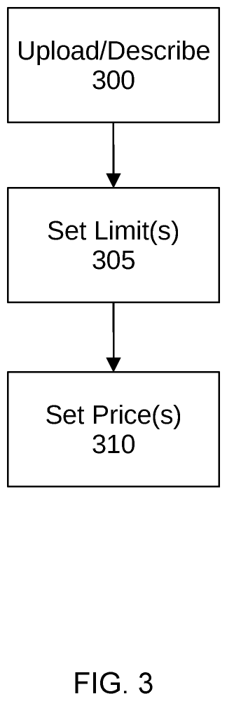

With reference to FIG. 3, a seller or administrator posts a good (e.g., product) or service for a raffle and sets parameters. In step 300, files are uploaded (e.g., photos) and information describing the good or service is provided. The good or service may be anything of value, such as merchandise, a trip, a cruise, a meal at a restaurant, a meeting with a celebrity or politician, or something else. Limits are set in step 305. The limits may be any limits relating to the raffle, such as, but not limited to the maximum value of raffle tickets that may be sold, the maximum number of raffle tickets that may be sold, the time during which raffle tickets may be sold, the end user locations where raffle tickets may (or may not) be procured.

In one implementation, the maximum value of raffle tickets that may be sold and/or the maximum number of raffle tickets that may be sold include raffle tickets to cover the value of the product or service being raffled plus an administrative fee. In one nonlimiting example, the administrative fee is 10% of the value of the product or service. Thus, if a product or service is valued at $100, the maximum value of the raffle tickets sold will be $110, of which $100 will go to the seller and $10 will go to the administrator.

By capping the maximum value of raffle tickets that may be sold and/or the maximum number of raffle tickets that may be sold, a system and method according to the invention increases a purchaser's odds of winning. It also increases the value of each raffle ticket. In an uncapped system, the total raffles sold may greatly exceed the value of the object being raffled. Chances of winning are diluted as additional tickets are sold. By way of example, instead of a 1/100 chance, a ticket may provide a 1/1000 chance, if 1000 tickets are sold rather than 100 tickets. In such a system, each ticket is far less valuable. While such a system may provide a windfall for the seller and/or administrator, its does so at the expense of the purchasers of the tickets. Thus, a capped raffle protects purchasers of raffle tickets by fixing the probability of winning per ticket.

The administrative fee may be a flat fee, a percentage, or a combination of a flat fee plus a percentage. The flat fee and/or percentage may be variable, such as according to the value of the product or service, or according to the total amount of products or services raffled by or on behalf of a seller using the system. For example, volume incentives may be provided.

Optionally, the user or an administrator may set prices, as in step 310. Prices may be for a single raffle ticket and/or for a plurality of raffle tickets. Volume discounts may, or may not be, offered. For example, the price per raffle ticket may be less if a user purchases twenty raffle tickets instead of one raffle ticket.

Referring again to FIG. 2, after the limit of raffle tickets has been sold, a selection method is invoked, as in step 230. In one implementation, each purchased raffle ticket has been assigned a unique id. The raffle tickets may be numbered consecutively at the time of purchase. Alternatively, each unique id may be stored in a list or table in an order, such, but not limited to, the order in which they were purchased. A Random Number Generator (RNG) is invoked to generate a “random” number that can be correlated with a purchased raffle ticket. For example, if 1000 raffle tickets were purchased, the RNG may generate a number from 0 to 999. If for example, the RNG generates the number 248, then the 248^{th} raffle ticket id in the list or table is selected as the winner. The raffle ticket id is related to end user (e.g., purchasing consumer) information in a database.

The invention is not limited to a particular RNG. The RNG may be a Pseudo-Random Number Generator (PRNG) or a True Random Number Generator (TRNG), although PRNGs are considered more practical. A PRNG is a deterministic algorithm that generates a “random looking” sequence of numbers based upon a seed value input. A PRNG needs some seed value to initiate the sequence generation. Given the same starting conditions (e.g., seed value), a PRNG will always give the same sequence. Hence, the name “Pseudo-Random” Number Generator. Most modern programming languages, and mathematical applications (e.g., spreadsheet programs) include one or more PRNG functions, many of which allow programmed input of a seed value. Additionally, many alternative numerical algorithms for PRNGs are available.

To improve the “randomness” of a PRNG, in one embodiment of the invention, a PRNG takes nondeterministic events from the environment and turns them into a seed input for a PRNG. By way of example and not limitation, in one embodiment, a PRNG for a raffle system according to principles of the invention uses, as a seed, the current system time when the PRNG of the selection process is run. In another embodiment, the PRNG may use the system time at the time of purchase of the 1st, last or nth raffle as a seed. In yet another embodiment, the PRNG may use a function that receives as inputs one or more such system times to calculate a seed. As the system time may be in milliseconds, and the exact time at which any of these events (e.g., random number generation, nth purchase, etc . . . ) occurs on the executing computer system (e.g., server 155) is unpredictable, such a seed is nondeterministic. With a nondeterministic seed, the PRNG provides an unpredictable output.

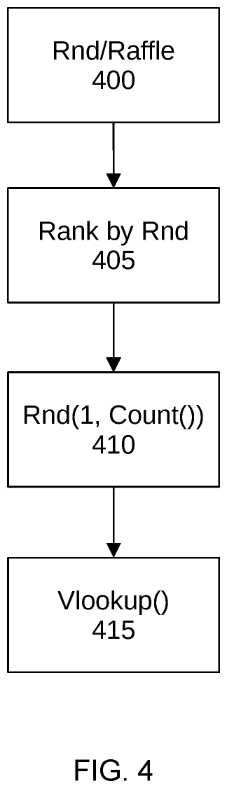

FIG. 4 is a high level flowchart of an exemplary selection methodology for a raffle method according to principles of the invention. The exemplary selection methodology entails generating a random number for each raffle, as in step 400. Each raffle may be identified with a unique raffle ID. Raffle IDs may be generated sequentially (e.g., 000001, 000002, . . ). In step 400 the generated random number is associated with the raffle. Each raffle will have a raffle ID and a generated random number associated with the raffle ID. The random number may be generated using an RNG as described above.

In step 405, the raffles are ranked. The raffles may be ranked by their associated random numbers. The raffle with the greatest random number may be ranked first, i.e., ranked 1. The raffle with the lowest random number may be ranked last, e.g., ranked 10 out of 10 raffles. The rank is associated with each raffle. Thus, each raffle will have a raffle ID, a generated random number and a rank associated with the raffle ID.

In step 410 the total number of raffles is determined. By way of example and not limitation, a count( )function may be used to determine the total number of raffles in a list or table that includes the raffle ID for each raffle sold for an item. Additionally, an integer random number is generated within the range of 1 to the total number of raffles. For example, if 10 raffles were sold, then the random integer will be from 1 to 10.

In step 415, a lookup function (e.g., Vlookup( )) is used to determine the raffle ID that corresponds to the rank that equals the random integer determined in step 410. That raffle ID identifies the winning raffle.

The selection methodology of FIG. 4 ranks raffle IDs according to generated random numbers and then randomly determines a rank for the winning raffle. Thus, the ranking is random and the selection of the rank for the winning raffle is random. This methodology helps ensure an unpredictable outcome.

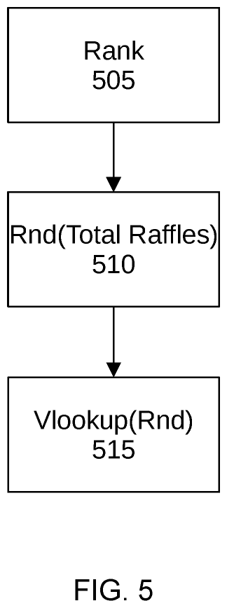

Another exemplary selection methodology for a raffle method according to principles of the invention is shown in the flowchart of FIG. 5. This methodology entails ranking the raffles according raffle ID, as ins step 505.

In step 510 the total number of raffles is determined. By way of example and not limitation, a count( )function may be used to determine the total number of raffles in a list or table that includes the raffle ID for each raffle sold for an item. Additionally, an integer random number is generated within the range of 1 to the total number of raffles. For example, if 10 raffles were sold, then the random integer will be from 1 to 10.

In step 515, a lookup function (e.g., Vlookup( )) is used to determine the raffle ID that corresponds to the rank that equals the random integer determined in step 510. That raffle ID identifies the winning raffle.

The selection methodology of FIG. 5 ranks raffle IDs and then randomly determines a rank for the winning raffle. Thus, the ranking is based upon the ID assigned when the raffle was purchased but the selection of a rank for the winning raffle is random. This methodology omits the random ranking of the methodology of FIG. 4 to simplify the process. The random selection of a rank for the winning raffle still helps ensure an unpredictable outcome.

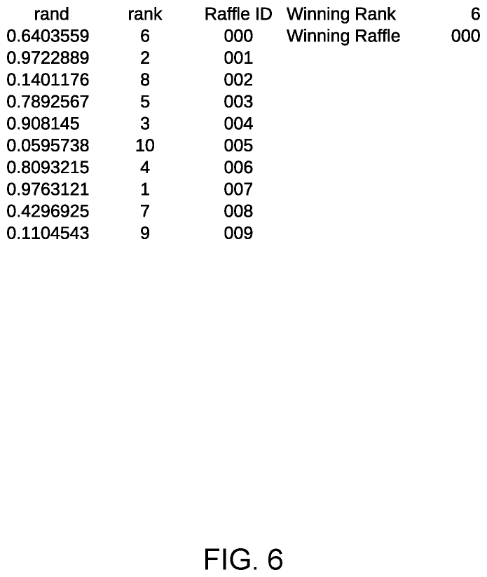

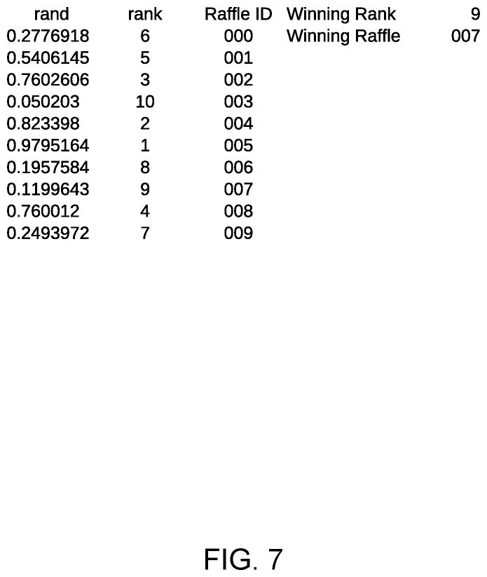

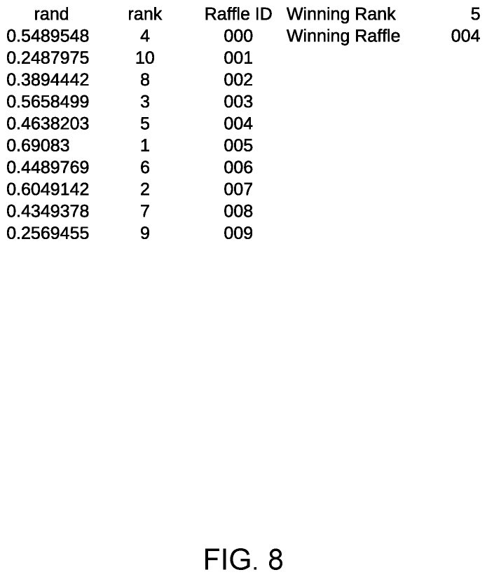

FIGS. 6-8 provide tables that conceptually illustrate random assignment, ranking, selection and lookup for an exemplary selection methodology for a raffle method according to principles of the invention. The first column of each table contains random numbers generated as in step 400. The second column of each table contains ranks as determined in step 405. The third column of each table contains raffle IDs. The winning rank in each table is an integer determined by rand om number generation, as in step 410. The winning raffle is the raffle ID associated with the rank that equals the integer determined in step 410. The winning raffle is determined by lookup as in step 415.

In each of the three tables of FIGS. 6-8, the random numbers are unique and unpredictable. Therefore, the rankings are different and unpredictable. Concomitantly, the randomly determined winning rank is unpredictable. Therefore, the raffle ID for the winning raffle is unpredictable.

After selection, the winner and other consumers are notified of the winning raffle ticket, as in step 235. Such notification may inform all consumers, except the winner, that they unfortunately did not win the raffle. The winner's identity may be released or held in confidence. The winner is notified that he or she procured the winning raffle ticket and therefore has won the posted good or service. The winner may announced, such as by posting on a website and/or application.

After selection, accounting steps are implemented, as in step 240. Such steps include disbursing funds. A portion of the funds may be paid to a seller or to a named beneficiary of the seller (e.g., a charitable or non-profit organization). A portion of the funds may be allocated to cover the administrative fees and expenses of the raffle system.

Advantageously, using a system and method according to principles of the invention, a seller may control the odds of winning for each raffle ticket by setting a maximum amount of tickets to be sold and/or a price per ticket. Illustratively, if the maximum value (i.e., the sum total) of all tickets to be sold is $100, and each ticket is priced at $1, then each ticket provides a 1 in 100 chance. If each ticket is priced at $10, then each ticket provides 1 in 10 chance.

In one implementation, a raffle application according to principles of the invention allows users to setup an account and/or log in using a social media account, such as a Facebook or Google account. By way of example and not limitation, the application may synchronize user profile data with each user login, thereby ensuring that changes made in the connection source are automatically updated in the application. Once users authenticate, they will be prompted to accept the permissions the raffle application has requested. Permissions allow access to information from the social media account, such as user and group information, content from the account, and information regarding related (e.g., Instagram) accounts. Permissions may also allow the raffle app to post content, such as notices and advertisements, to a user's social media account. Once a use authenticates and accepts, they will not be expected to re-authenticate unless the raffle application requires them to do so again.

A raffle system and method according to the invention may provide rewards for certain activities. For example, a user who refers a friend may receive a discount, credits or free raffle tickets.

A raffle system and method according to the invention may also be used for promotion of new products or services. For example, a business may raffle a product and offer each purchaser of a raffle ticket a free item or a discount. In the case of a restaurant, a free item may be something from restaurant's menu.

In one implementation, a seller may post a product. The product may have a certain value sought by the seller. For example, the seller may value the product at $100. If raffles are priced at $10 per raffle, the system may cap the number of raffles to be sold at:

$$Cap = ( 1 + F ) * \frac{Value}{Price}$$

The Cap is the total number of raffles to be sold. The Cap should always be rounded up to the next whole number. In this example, F corresponds to an administrative fee. It is a decimal that represents the administrative fee. Illustratively, if the administrative fee is 20% of the Value, then the decimal is 0.2. Value is the amount that a seller wants to receive for the product. Price is the price per raffle. By way of example, if the administrative fee is 20%, and the product Value is $100, and the price per raffle is $10, then the Cap is determined as:

$$Cap = ( 1 + 0.2 ) * \frac{100}{10} = 12$$

Selling twelve raffles at $10/raffle will cover the Value of the product and the administrative fee. In this manner, the number of raffles sold is limited to the number that will satisfy the value plus administrative fee.

Another aspect of the invention is value validation. An administrator of a raffle marketplace has an interest in ensuring the integrity of the marketplace. If users have been deceived or defrauded, the marketplace will not survive. To ensure that products are not excessively overpriced, a system and method according to principles of the invention may include a database of acceptable values for items and steps of comparing a value entered by a user with an acceptable value in the database. If the value for a product entered by the seller exceeds the acceptable value in the database, the system may prevent the transaction unless administrator approval is granted. Administrator approval may be granted or denied on an ad hoc basis. By way of example, a product that has been autographed by a celebrity, or that was previously owned by a celebrity, or that is a type of product that previously had no acceptable value in the database, or is a vintage item for which there is limited supply may be priced at an amount that requires ad hoc administrator review. Over time, the acceptable value database may be supplemented with additional acceptable values for such products.

Yet another aspect of the invention is transaction validation. Funds are transferred to the seller after the product is received by the winning purchaser, and/or after a determined period of time (e.g., 30 days) has passed after the transaction and/or receipt without objection from the purchaser. Receipt may be determined from shipper tracking information. Time may be allowed after the receipt date for a winning purchaser to object. A valid objection may be based upon material noncompliance with the product description, the product received in a damaged condition, or non-receipt of the product.

A raffle system according to principles of the invention provides technological advancements in selection, limits and valuation. The selection methodology assigns a random number to each raffle id for each raffle ticket sold. Each random number is unpredictable. Then the selection methodology ranks the raffle ids by their assigned random number. The ranking is also unpredictable. Then the selection methodology randomly generates an integer corresponding to the rank of the winning raffle id. The integer is unpredictable. Thus, the selection is swiftly made based upon three distinct unpredictable steps, making the winning raffle id unpredictable. This selection methodology is adaptable to other processes that may benefit from a random selection of an item from a list.

The limit aspects of the invention limit the number of raffles sold. Based upon the price per raffle, the number is limited to cover a desired selling price for the raffled product and administrative fees of the raffle system. The limiting steps maximize a participant's odds of winning, making each raffle more valuable. In an unlimited raffle, a participant's odds of winning by purchasing one raffle may be vanishingly low. These limiting steps may be applied to another methodology where the revenue generated from bids or raffles covers the selling price and administrative fee.

The valuation aspects of the invention help ensure integrity of the raffle. Pricing in accordance with market standards helps avoid deception and fraud. Comparing a proposed price (i.e., value) for a product with acceptable values helps avoid over-pricing. Where an acceptable value is unavailable, requiring additional steps for approval before a product may be raffled also helps avoid over-pricing. These valuation steps may be applied to any online marketplace to provide a streamlined product pricing check.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A raffle method comprising steps of:
a) associating a value with a product;
b) receiving a request to purchase a raffle;
c) determining if a raffle limit has been reached;
d) if the raffle limit has not been reached, selling a raffle in response to the request to purchase;
f) repeating steps b) through d) until the raffle limit has been reached;
f) assigning a raffle id to each purchased raffle, each purchased raffle being one raffle of a plurality of purchased raffles; and
g) randomly selecting one raffle id as a winning raffle id.

2. The raffle method of claim 1 wherein the step of randomly selecting one raffle id as a winning raffle id includes steps of ranking each raffle id according to a determined parameter, and randomly selecting a rank.

3. The raffle method of claim 2 wherein the determined parameter for each raffle id is a time of sale of the raffle to which the raffle id is assigned.

4. The raffle method of claim 2 wherein the step of randomly selecting a rank includes randomly generating an integer.

5. The raffle method of claim 2 wherein the step of randomly selecting a rank includes randomly generating an integer using a pseudo-random number generator.

6. The raffle method of claim 1 wherein the step of randomly selecting one raffle id as a winning raffle id includes steps of assigning a random number to each raffle id, ranking each raffle id according to the assigned random number, and randomly selecting a rank.

7. The raffle method of claim 6 wherein the step of randomly selecting a rank includes randomly generating an integer.

8. The raffle method of claim 6 wherein the step of randomly selecting a rank includes randomly generating an integer using a pseudo-random number generator.

9. The raffle method of claim 7 wherein the step of randomly selecting a rank includes randomly generating an integer using a pseudo-random number generator.

10. The raffle method of claim 6 wherein the step of assigning a random number to each raffle id includes randomly generating a number for each raffle id.

11. The raffle method of claim 7 wherein the step of assigning a random number to each raffle id includes randomly generating a number for each raffle id.

12. The raffle method of claim 6 wherein the step of assigning a random number to each raffle id includes randomly generating a number for each raffle id using a pseudo-random number generator.

13. The raffle method of claim 1 wherein the step of associating a value with a product includes receiving a proposed value, comparing the proposed value with an acceptable value, determining of the acceptable value equals or exceeds the proposed value, and if the acceptable value equals or exceeds the proposed value, then equating the value to the proposed value.

14. The raffle method of claim 2 wherein the step of associating a value with a product includes receiving a proposed value, comparing the proposed value with an acceptable value, determining of the acceptable value equals or exceeds the proposed value, and if the acceptable value equals or exceeds the proposed value, then equating the value to the proposed value.

15. The raffle method of claim 7 wherein the step of associating a value with a product includes receiving a proposed value, comparing the proposed value with an acceptable value, determining of the acceptable value equals or exceeds the proposed value, and if the acceptable value equals or exceeds the proposed value, then equating the value to the proposed value.

16. The raffle method of claim 1, wherein the step of determining if a raffle limit has been reached includes determining a first amount equal to the value and an administrative fee, determining the product of the number of raffles purchased and a price per raffle; determining if the product is less than the first amount, and if the product is not less than the first amount, determining that a raffle limit has been reached, and if the product is less than the first amount, determining that a raffle limit has not been reached.

17. The raffle method of claim 2, wherein the step of determining if a raffle limit has been reached includes determining a first amount equal to the value and an administrative fee, determining the product of the number of raffles purchased and a price per raffle; determining if the product is less than the first amount, and if the product is not less than the first amount, determining that a raffle limit has been reached, and if the product is less than the first amount, determining that a raffle limit has not been reached.

18. The raffle method of claim 7, wherein the step of determining if a raffle limit has been reached includes determining a first amount equal to the value and an administrative fee, determining the product of the number of raffles purchased and a price per raffle; determining if the product is less than the first amount, and if the product is not less than the first amount, determining that a raffle limit has been reached, and if the product is less than the first amount, determining that a raffle limit has not been reached.

19. The raffle method of claim 13, wherein the step of determining if a raffle limit has been reached includes determining a first amount equal to the value and an administrative fee, determining the product of the number of raffles purchased and a price per raffle; determining if the product is less than the first amount, and if the product is not less than the first amount, determining that a raffle limit has been reached, and if the product is less than the first amount, determining that a raffle limit has not been reached.

20. The raffle method of claim 15, wherein the step of determining if a raffle limit has been reached includes determining a first amount equal to the value and an administrative fee, determining the product of the number of raffles purchased and a price per raffle; determining if the product is less than the first amount, and if the product is not less than the first amount, determining that a raffle limit has been reached, and if the product is less than the first amount, determining that a raffle limit has not been reached.
